(19) United States
(12) Patent Application Publication
(10) Pub. No.: US 2026/0293795 A1
(43) Pub. Date: Oct. 1, 2026

(54) DEPTH CONTROL BAND FOR AGRICULTURAL WHEEL

(71) Applicant: SCHAFFERT MANUFACTURING COMPANY, INC., Indianola, NE (US)

(72) Inventor: Paul E. SCHAFFERT, Indianola, NE (US)

(21) Appl. No.: 19/634,442

(22) Filed: Mar. 31, 2026

Related U.S. Application Data
(60) Provisional application No. 63/780,737, filed on Mar. 31, 2025.

(51) Int. Cl. A01C 7/20

(52) U.S. Cl. CPC A01C 7/203; A01C 7/208

(57) ABSTRACT

A trailing arm assembly for connection with a row unit of an agricultural planter includes a closer frame and a walking arm assembly pivotally connected to the closing frame. The walking arm assembly includes a first closing wheel rotationally mounted toward a first end of the walking arm assembly and a second closing wheel trailing the first closing wheel and rotationally mounted toward a second end of the walking arm assembly such that as the first closing wheel lifts, the second closing wheel drops and vice versa. In such an example, the first closing wheel includes a circular disc having a first surface and a second surface opposite the first surface, the circular disc including a first outer diameter, and a depth control band extending laterally from the first surface, the depth control band including a second outer diameter less than the first outer diameter.

### CROSS-REFERENCE TO RELATED APPLICATIONS

This application claims the benefit of priority pursuant to 35 U.S.C. § 119(e) of U.S. Provisional Patent Application No. 63/780,737, filed Mar. 31, 2025, entitled “Depth Control Band for Agricultural Wheel,” which is hereby incorporated by reference herein in its entirety.

### FIELD

The described embodiments of the present disclosure relate to trailing arm assemblies of agricultural planters. Specifically, the described embodiments of the present disclosure relate to depth control bands for trailing arm assemblies.

### BACKGROUND

Agricultural seed planting is typically accomplished by multi-row planters. Each planter may include multiple row units adapted for clearing debris on the field surface, opening a seed furrow, depositing seeds within the furrow, and closing the seed furrow around the seeds. In some cases, each row unit of the planter may also open a fertilizer furrow adjacent to each seed furrow, deposit liquid fertilizer in each fertilizer furrow, and close each fertilizer furrow.

Planters are increasingly used in no-till situations, resulting in the planter traversing fields with substantial deviation in the field surface and a substantial number of obstructions (e.g., debris, clods, stubble, old furrows, etc.). Planters are also used in wet soil conditions. Furrow closer assemblies, which trail behind furrow opener assemblies on the row unit of the planter, typically include a furrow closer wheel or disc positioned to move dirt back over the open furrow in order to close it. The depth at which the closer wheel penetrates the soil is important to control to ensure proper and consistent furrow closing. However, current furrow closer assemblies lack such depth control such that furrow closer wheels often penetrate too deep into the soil, especially in wet, soft soil conditions and over rough field surfaces.

Thus, there is a need in the art for a planter capable of controlling the penetration depth of furrow closer wheels to accommodate variable soil and field surface conditions.

### SUMMARY

Examples of the present invention are directed to depth control bands for trailing arm assemblies.

In one example of the present disclosure, a trailing arm assembly for connection with a row unit of an agricultural planter includes a closer frame and a walking arm assembly pivotally connected to the closing frame. The walking arm assembly includes a first closing wheel rotationally mounted toward a first end of the walking arm assembly and a second closing wheel trailing the first closing wheel and rotationally mounted toward a second end of the walking arm assembly such that as the first closing wheel lifts, the second closing wheel drops and vice versa. In such an example, the first closing wheel includes a circular disc having a first surface and a second surface opposite the first surface, the circular disc including a first outer diameter, and a depth control band extending laterally from the first surface, the depth control band including a second outer diameter less than the first outer diameter.

In one example, the band includes a tubular structure. In one example, the tubular structure includes a central longitudinal axis parallel to a rotational axis of the disc. In one example, the depth control band includes a thickness extending greater than 0.5 inches along the central longitudinal axis. In one example, the depth control band is disposed concentric with the disc. In one example, the first outer diameter is between 6-inches and 12-inches and the second outer diameter is between 4-inches and 10-inches. In one example, the first surface faces away from the closing frame and the second surface faces toward the closing frame such that the disc is disposed between the depth control band and the closing frame. In one example, the disc is angled such that the first surface faces downward toward a field surface during use.

In one example of the present disclosure, a trailing arm assembly for an agricultural planter includes a closer frame, a walking arm pivotally connected to the closing frame, the walking arm having a first end and a second end opposite the first end, the second end trailing the first end, a first or fertilizer disc rotatably connected to the second end, and a closing wheel rotatably connected to the first end, the closing wheel including a closer disc having a body between a first surface and a second surface opposite the first surface, the closer disc including a first outer diameter, and a tubular depth control band extending from the first surface concentric with the body, the depth control band including an outer diameter less than the first outer diameter.

In one example, the depth control band is welded to the body. In one example, the depth control band is removably secured to the body. In one example, the depth control band is integrally formed as a single piece with the body. In one example, the closing wheel further includes a central hub defining a rotational axis and the depth control band is disposed between the central hub and an outer perimeter edge of the body. In one example, the depth control band includes a thickness extending longitudinally along the rotational axis and the thickness extends at least 0.5 inches away from the first surface. In one example, the closing wheel is a first closing wheel, the depth control band is a first depth control band, and the trailing arm assembly further includes a second closing wheel having a second depth control band extending therefrom.

In at least one example of the present disclosure, a closing wheel configured to be rotatably secured to trailing arm assembly of an agricultural planter includes a circular disc having a first surface and a second surface opposite the first surface, the circular disc including an outer radial edge defining a first outer diameter, a central hub defining an axis of rotation, and a tubular depth control band extending laterally from the first surface between the outer radial edge and the hub, the depth control band including a second outer diameter less than the first outer diameter.

In one example, the second outer diameter is at least 2-inches less than the first outer diameter. In one example, the depth control band extends laterally at least 0.5 inches. In one example, the disc includes a first metal, the depth control band includes a second metal, and the depth control band is welded to the disc. In one example, the disc includes a first material, the depth control band includes a second material different from the first material, and the depth control band is removably secured to the disc.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 depicts an embodiment of an agricultural tractor pulling a planter assembly;

FIG. 2 depicts a rear perspective view thereof;

FIG. 3 depicts a rear perspective view of an example of a furrow closer assembly;

FIG. 4 depicts a side view of an example of a furrow closer assembly;

FIG. 5 depicts a perspective view of an example of a furrow closer disc;

FIG. 6 depicts a front view of an example of a furrow closer disc; and

FIG. 7 depicts a side view of the disc shown in FIG. 6.

### DETAILED DESCRIPTION

The description that follows includes sample systems, methods, and apparatuses that embody various elements of the present disclosure. However, it should be understood that the described disclosure may be practiced in a variety of forms in addition to those described herein.

The described embodiments of the present disclosure relate to trailing arm assemblies of agricultural planters. Specifically, the described embodiments of the present disclosure relate to depth control devices or systems for trailing arm assemblies. In at least one embodiment, a trailing arm assembly of an agricultural planter can include a furrow closer wheel or disc and an additional wheel trailing the closer disc. The additional wheel can include a wheel configured to mellow and work the soil after the closer disc has closed the furrow. In some embodiments, the closer disc and the additional trailing wheel of the closer assembly can be connected to opposing ends of a single arm (e.g., a “walking arm”) pivotally mounted between the closer disc and the trailing wheel to a closer frame of the closer assembly. Further, the closer assembly can be adjustably secured to an opener assembly of the trailing arm assembly via a four-bar linkage or other adjustable mechanism. The walking arm and the four-bar linkage can provide upward and downward freedom of movement for the wheels when traversing uneven field surfaces.

The closer disc may be mounted to the closer assembly ahead of the trailing wheel and pivotally mounted, along with the trailing wheel, to the closer frame. In order to prevent the leading closer disc from pivoting too far downward and too deep into the soil, especially in soft or wet soil conditions, embodiments of closer discs described herein can include a depth control band. The depth control band can be configured to prevent or inhibit the closer disc from penetrating too deep into the soil. In one embodiment, the depth control band can include a cylindrical portion or wall of the disc extending axially from the disc parallel to an axis of rotation of the disc. The outer diameter of the cylindrical wall can be less than the outer diameter of the disc. In this way, when the outer perimeter of the closer disc penetrates the soil during operation, the depth control band includes an outer cylindrical surface configured for contacting the soil surface and preventing further penetration of the disc beyond the depth band. The difference in the outer diameter of the depth band and the outer diameter of the disc determines how deep (e.g., a distance) the disc can penetrate into the soil.

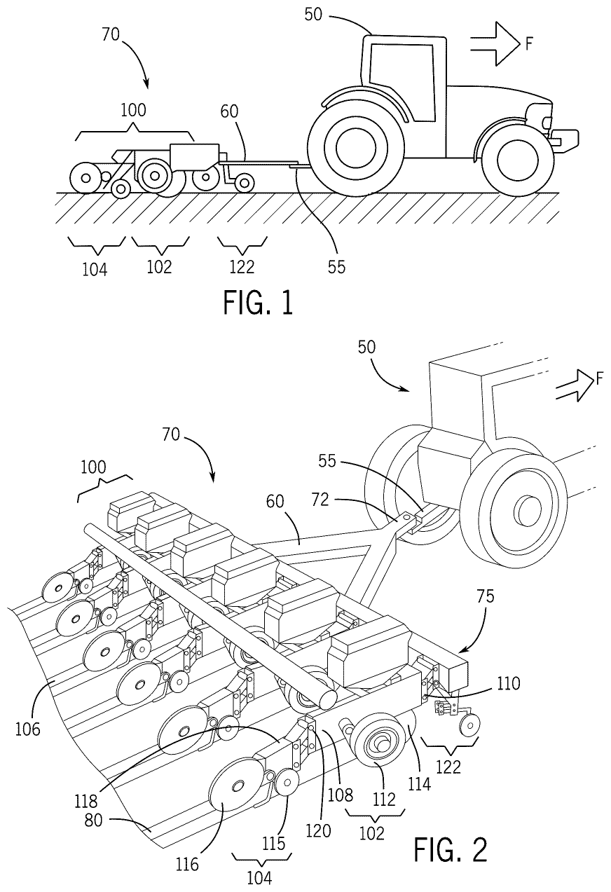

These and other embodiments are discussed below with reference to FIG. 1-7. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

An exemplary embodiment of an agriculture planter 70 having one or more trailing arm assemblies 100 attached to an agricultural tractor 50 is shown in FIGS. 1 and 2. The closer wheels and depth control bands of the present disclosure may be used with the agriculture planter 70 and/or trailing arm assemblies 100, as described herein. For purposes of illustration, the agricultural tractor 50 may have a hitch receiver 55 extending rearward therefrom. As illustrated in FIG. 2, the planter 70 may include a tool bar 75 from which a yoke or frame 60 with a tongue or hitch 72 extends in a forward direction F. The hitch 72 connects with the hitch receiver 55 to couple the planter 70 to the tractor 50. Various planter components are supported on the tool bar 75 and extend therefrom in a rearward direction (opposite the forward direction F). The tractor 50 tows the planter 70 in the forward direction F indicated by the arrow and provides power to the planter 70 (e.g., via a power take off (“PTO”), not shown) for powering the operations of the planter 70. Additional operations of the planter 70 may be powered by hydraulics or electrical motors (not shown) powered by the tractor 50.

Components of the planter 70 may include a plurality of trailing arm assemblies 100. The trailing arm assemblies 100 may function as row units for planting seeds and distributing liquid fertilizer. Each trailing assembly 100 may be coupled with the tool bar 75 or yoke that extends from the front of the trailing assembly 100. Each trailing assembly 100 may be equipped with a furrow opener assembly 102. Each trailing assembly 100 may also be equipped with a trailing furrow closer assembly 104. As used herein, the term “row unit” may refer to a portion of the trailing assembly 100 configured to open and close a single furrow (e.g., furrow 106). For example, a row unit may include a single furrow opener assembly 102 coupled to and ahead of a single furrow closer assembly 104 to open and close, respectively, the same furrow 106.

In the exemplary embodiment shown, the furrow opener assembly 102 may include an opener assembly frame 108, which may be connected to the tool bar 75 via a parallel linkage 110, such as any of the linkage assemblies or parallel linkages described herein. The parallel linkage 110 allows the furrow opener assembly 102 and the furrow closer assembly 104 to move/translate up and down vertically (generally orthogonal to forward direction F) to follow the terrain (e.g., contours of the field), overcome obstacles (e.g., debris or the like), or otherwise negotiate changes in a surface 80 of a field. The furrow opener assembly 102 may include a gauge wheel 112 and an opener disc 114, among other components. The opener disc 114 may also be referred to as an opener wheel. The furrow closer assembly 104 may include one or more closer wheels, including a closer disc 115 leading a trailing wheel 116. The closer disc 115 can be configured to push or direct soil back over the open furrow to close the furrow 106. The trailing wheel 116 can be configured to mellow and work the soil after the furrow 106 has been closed by the closer disc 115. In some embodiments, the furrow closer assembly 104 may include a separate fertilizer opener wheel and a fertilizer dispenser. The vertical movement provided by the linkage 110 may allow the trailing arm assemblies 100 to follow or translate up and down as the opener discs 114, and closer wheels (e.g., the closer disc 115 and the trailing wheel 116) negotiate over or through an obstruction in a field surface 80 without adversely impacting seed deposit depth or resulting in damage to the components of the agricultural planter 70.

Because the trailing arm assemblies 100 are able to adjust to the contours of and variances in the field surface 80 through vertical translation via the parallel linkage 110, the opener discs 114 may be in generally consistent contact with the field surface 80, which may improve opening of furrows 106. Similarly, the trailing furrow closer wheels, including the closer disc 115 and the trailing wheel 116 may be in consistent contact with the field surface 80, which improves closing of the seed and fertilizer furrows 106.

The furrow opener assembly 102 may be coupled to the tool bar 75 via a connection that allows the trailing assembly 100 to move relative to the tool bar 75. In any of the embodiments contemplated herein, the connection may be configured to maintain an approximately constant relative orientation between the furrow opener assembly 102 and the tool bar 75 through the range of motion of the trailing assembly 100. For example, the furrow opener assembly 102 may connect to the tool bar 75 via the parallel linkage 110. In any of the embodiments disclosed herein, the parallel linkage 110 may include a pair of linkages that are generally arranged along a central longitudinal plane of the row unit.

The furrow closer assembly 104 may be coupled to the furrow opener assembly 102, for example to the opener frame 108, via a connection that allows the furrow closer assembly 104 to move relative to the furrow opener assembly 104. In any of the embodiments described herein, the connection may be configured to maintain an approximately constant relative orientation between the furrow closer assembly 104 and the furrow opener assembly 102 through the range of motion of the furrow closer assembly 104. For example, the furrow closer assembly 104 may include a closer assembly frame 118, which may be connected to the furrow opener assembly 102, for example to the opener frame 108, via a parallel linkage 120, such as any of the linkage assemblies described herein. In any of the embodiments contemplated herein, the parallel linkage 120 may include at least a pair of linkages that are generally arranged along a central longitudinal plane of the row unit. In at least one embodiment, the trailing assembly 100 may also include a leading assembly 122 disposed ahead or forward relative to the furrow opener assembly 102.

Any of the features, components, and/or parts, including the arrangements and configurations thereof shown in FIG. 1-2 may be included, either alone or in any combination, in any of the other examples of devices, features, components, and parts shown in the other figures. Likewise, any of the features, components, and/or parts, including the arrangements and configurations thereof shown in the other figures may be included, either alone or in any combination, in the example of the devices, features, components, and parts shown in FIG. 1-2.

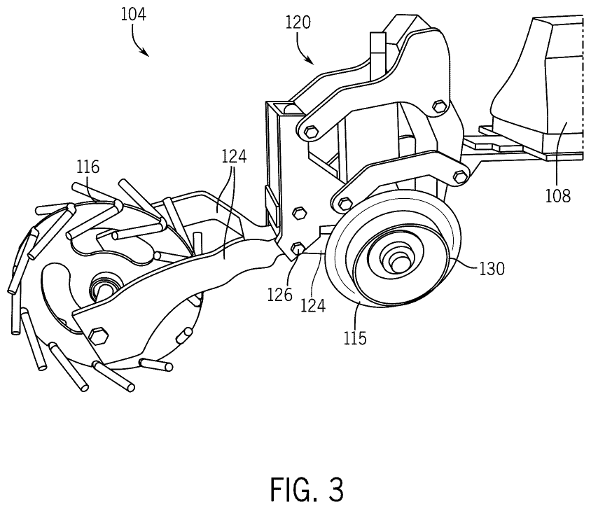

FIG. 3 illustrates a perspective view of the closer assembly 104 including a four-bar linkage 120 securing the closer disc 115 and the trailing wheel 116 to the opener assembly frame 108. In at least one embodiment, the closer disc 115 and the trailing wheel 116 are rotatably coupled at opposing ends of a pivot arm 124. In one embodiment, the pivot arm 124 is a walking beam rotatable about a pivot 126 such that when one end raises, the other end lowers, and vice versa. In at least one embodiment, as the closer disc 115 and the trailing wheel 116 are pulled along an uneven field surface, both the closer disc 115 and the trailing wheel 116 maintain adequate downforce and contact with the surface because of the rotation of the walking arm 124 and the vertical translation of the closer assembly 104 relative to the opener assembly 108 via the four-bar linkage 120.

In order to control the depth at which the closer disc 115 penetrates the soil, the closer disc 115 can include a depth control band 130 extending outward from the closer disc 115. While the outer edge of the closer disc 115 can penetrate into the soil beyond a top surface of the soil, the depth control band 130 forms an extended surface area to contact with the soil to prevent or inhibit further penetration beyond the depth control band 130.

In at least one embodiment, as shown in FIG. 3, the trailing wheel 116 can include or be a chicken tracker wheel or other wheel configured to mellow and work the soil of on the top surface of the closed furrow. For example, after the closer disc 115 has closed the furrow. The illustrated trailing wheel 116 is a chicken tracker wheel having treads for mellowing and working the soil. Other wheels and discs can also be rotatably secured to the walking arm 124.

Any of the features, components, and/or parts, including the arrangements and configurations thereof shown in FIG. 3 may be included, either alone or in any combination, in any of the other examples of devices, features, components, and parts shown in the other figures. Likewise, any of the features, components, and/or parts, including the arrangements and configurations thereof shown in the other figures may be included, either alone or in any combination, in the example of the devices, features, components, and parts shown in FIG. 3.

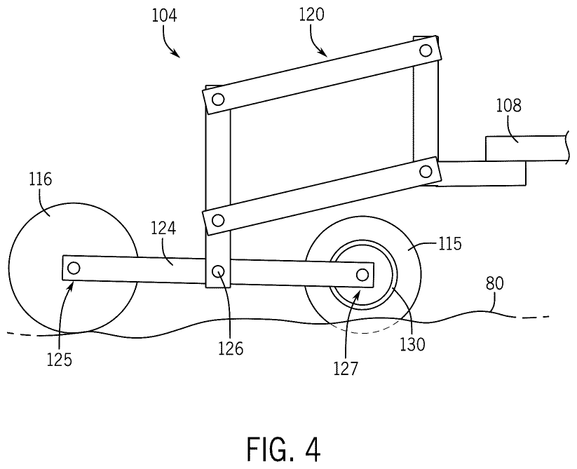

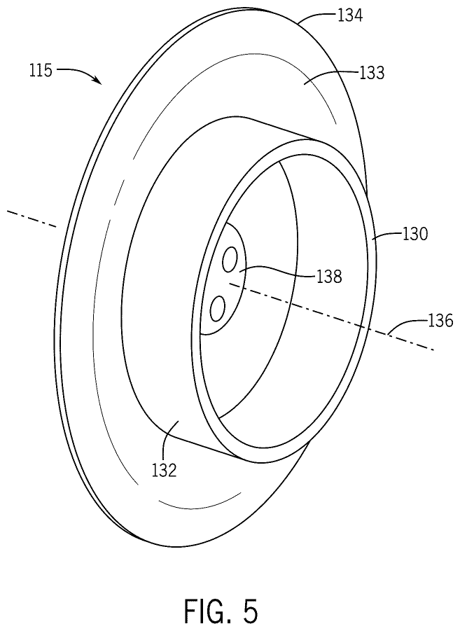

FIG. 4 illustrates a side view of a furrow closer assembly 104 including a walking arm 124 pivotally secured at a pivot 126 to a furrow opener assembly 108 via a four-bar linkage 120. The walking arm 124 may include a first end 127 and a second end 125 opposite the first end 127. The pivot 126 can be positioned between the first end 127 and the second end 125. In at least one embodiment, the furrow closer assembly 104 includes a furrow closer disc 115 rotationally mounted toward or at the first end 127 of the walking arm 124 and a trailing wheel 116 rotationally mounted toward or at the second end 125 of the walking arm 124. The pivot 126 is disposed between the closer disc 115 and the trailing wheel 116. In one embodiment, the closer disc 115 is a first closer disc and the trailing wheel 116 includes or is a second closer disc, which can also include a depth control band. In one embodiment, the trailing wheel 116 can include a fertilizer disc.

In FIG. 4, the furrow closer assembly 104 is shown being pulled along a field surface 80 such that the closer disc 115 and the trailing wheel 116 contact and/or penetrate the surface 80. In examples where the surface 80 is uneven, the closer disc 115 and the trailing wheel 116 are mounted to the walking arm 124 such that as the closer disc 115 lifts, the trailing wheel 116 drops and vice versa. For example, a force or moment imparted at one of the wheels 115, 116 on one side of the pivot 126 can induce an opposing force or moment at the opposite side. In this manner, forces can be distributed between each of the wheels 115, 116 by the walking arm 124. In the illustrated embodiment, the closer disc 115 includes a depth control band 130 such that a portion of the closer disc 115 penetrates below the surface 80 but the depth control band 130 does not or resists further penetration. Rather, the depth control band 130 presses against the surface 80 and prevents or inhibits further penetration of the closer disc 115 below the surface 80.

Any of the features, components, and/or parts, including the arrangements and configurations thereof shown in FIG. 4 may be included, either alone or in any combination, in any of the other examples of devices, features, components, and parts shown in the other figures. Likewise, any of the features, components, and/or parts, including the arrangements and configurations thereof shown in the other figures may be included, either alone or in any combination, in the example of the devices, features, components, and parts shown in FIG. 4.

FIG. 5 illustrates an embodiment of a closer disc 115, including a circular main body or disc 133 having an outer, radial, perimeter feature, or edge 134 configured to cut through the surface 80 during use. The outer edge 134 can be continuous or discontinuous. The outer edges 134 can be formed by teeth, blades, or the like. The outer edge 134 can be concentric about the axis of rotation 136, or the outer edge can be scalloped, offset, or the like. In one embodiment, the closer disc 115 (also referred to as a closing wheel or closer wheel) includes a central hub 138 defining an axis of rotation 136 of the closer disc 115.

In at least one embodiment, the depth control band 130 can be a tubular structure extending from a surface of the closer disc 115. In one embodiment, the tubular structure or cylindrical structure has a thickness extending parallel to the axis of rotation 136. In such an embodiment, the axis of rotation 136 can include the central longitudinal axis of the cylindrical depth control band 130. The depth control band 130 may extend laterally (e.g., axially parallel to or otherwise along the axis of rotation 136) between the outer radial edge 134 and the hub 138. The lateral extension or the thickness of the depth control band 130 defines an outer surface 132 and surface area configured to contact the field surface 80 and prevent or inhibit penetration of the depth control band 130 below the surface 80. The depth control band 130 can be continuous or discontinuous (e.g., segmented or two or more separately formed features). For example, the depth control band 130 can include spaced apart features forming the outer surface 132 and defining voids therebetween. In some examples, the depth control band 130 can be castellated or have a notched or indented outer surface.

In at least one embodiment, the disc 115 includes the disc body 133 defining the outer radial edge 134 and includes a first material. The depth control band 130 may include a second material. In at least one embodiment, the first material is a metal and the second material is a metal. The first material and the second material may be formed of the same material or metal. In some examples, the depth control band 130 may be welded to the disc body 133. In at least one embodiment, the first material is different from the second material. In at least one embodiment, the depth control band 130 is removably secured to the disc body 133. In at least one embodiment, the depth control band 130 is integrally formed as a single piece with the disc body 133. For example, via molding or other manufacturing process forming the closer disc 115 as a single, unitary part.

Any of the features, components, and/or parts, including the arrangements and configurations thereof shown in FIG. 5 may be included, either alone or in any combination, in any of the other examples of devices, features, components, and parts shown in the other figures. Likewise, any of the features, components, and/or parts, including the arrangements and configurations thereof shown in the other figures may be included, either alone or in any combination, in the example of the devices, features, components, and parts shown in FIG. 5.

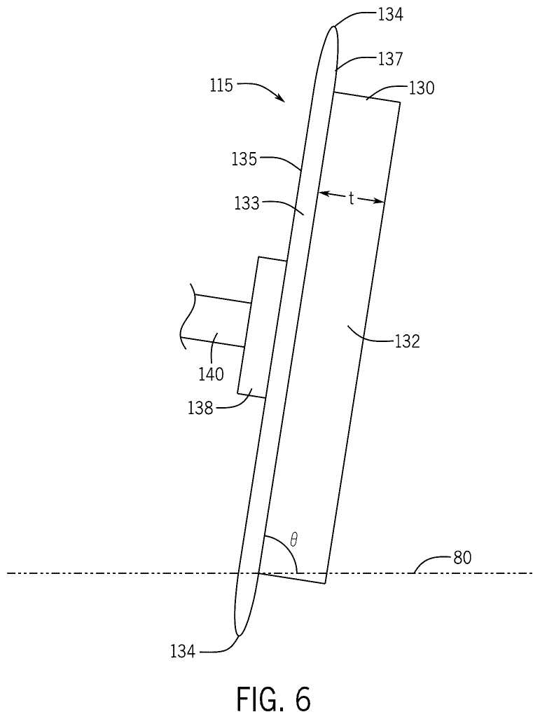

FIG. 6 illustrates a side view of an embodiment of a closer disc 115 rotationally coupled to an axle 140 via a hub 138. The closer disc 115 can include a body 133 defined between first and second opposing sides 137 and 135, respectively. The body 133 also defines an outer, perimeter, radial edge 134 configured to penetrate through the surface 80 of a field. In at least one embodiment, and a depth control band 130 extends laterally from the first surface 137 at a thickness t. The thickness t defines the outer surface contact area 132 that resists or prevents the depth control band 130 from penetrating through the surface 80, as shown in FIG. 6. The larger the thickness t of the depth control band 130, the greater the area 132. For a larger thickness t or the greater the area 132, the depth control band 130 can have a greater the resistance to surface penetration, and vice versa. In order to provide enough surface area 132 to prevent or reduce penetration, the thickness t of the depth control band 130 may be at least about 0.5 inches. In some embodiments, such as depending on the weight of the system or the downforce applied from the closer disc 115 onto the surface 80, the thickness t can be at least 1 inch. In some embodiments, the thickness t can be at least about 1.5 inches, at least about 2 inches, or at least about 3 inches or more.

In at least one embodiment, wheel 115 is positioned such that the first surface 137 faces away from the closing frame. The second surface 135 faces toward the closing frame (also referred to as a “closer frame”). In such an example, the disc body 133 is disposed between the depth control band 130 and the closing frame. As shown in FIG. 6, the axle 140 may extend to the closing frame. In at least one embodiment, the disc 115 is angled relative to the surface 80 at an angel θ such that the first surface faces downward toward the field surface 80 during use. In such an embodiment, the depth control band 130 is tilted to face downward toward the surface 80 during use. The second surface 135 of the disc 115, or the disc body 133, faces upward and away from the surface 80.

Tilting the wheel 115 at the angle θ can facilitate moving soil to assist in closing a seed furrow by the outer edge 134. The angle θ can be selected to break down a sidewall of the furrow or direct soil towards the furrow. In some examples, by angling the wheel at angle θ, at least a portion of the depth control band extends into the field surface 80. The outer surface 132 can prevent or inhibit deep penetration while the depth control band 130 assists in moving soil. In some examples, the angle θ can ensure engagement between the depth control band 130 and the field surface 80 to maintain a consistent depth of penetration by the outer edge 134. For example, if the wheel 115 were to be tilted in an opposite direction, the depth control band 130 may not engage with the field surface 80 until the outer edge 134 penetrates a comparatively greater depth.

Any of the features, components, and/or parts, including the arrangements and configurations thereof shown in FIG. 6 may be included, either alone or in any combination, in any of the other examples of devices, features, components, and parts shown in the other figures. Likewise, any of the features, components, and/or parts, including the arrangements and configurations thereof shown in the other figures may be included, either alone or in any combination, in the example of the devices, features, components, and parts shown in FIG. 6.

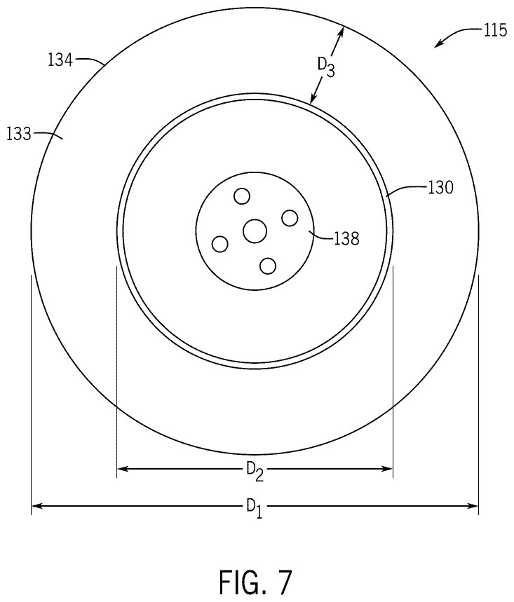

FIG. 7 illustrates a front plan view of the closer disc 115 shown in FIG. 5. In the illustrated embodiment, the closer disc 115 may be circular having an outer perimeter radial edge 134 and defining or including a first outer diameter D₁. The depth control band 130 may include or define a second outer diameter D₂ less than the first outer diameter D₁. In at least one embodiment, the depth control band 130 may be disposed concentric with the disc 115, including concentric with the outer perimeter radial edge 134 of the disc body 133. The difference between the first outer diameter D₁ and the second outer diameter D₂ can result in a penetration depth D₃ of the closer disc 115.

In at last one embodiment, in order to achieve the appropriate penetration depth D₃ for sufficient furrow closing, the first outer diameter D₁ may be between about 6-inches and about 12-inches while the second outer diameter D₂ may be between about 4-inches and about 10-inches. In at least one embodiment, the second outer diameter D₂ is at least about 2-inches less than the first outer diameter D₁. In such an embodiment, the penetration depth D₃ may be at least about 1-inch. In other examples, the penetration depth D₃ may be at least 2 inches, 3 inches, 4 inches, or the like. Other diameters and penetration depths can be utilized to accommodate needed penetration depths depending on soil conditions and seeds being planted.

Any of the features, components, and/or parts, including the arrangements and configurations thereof shown in FIG. 7 may be included, either alone or in any combination, in any of the other examples of devices, features, components, and parts shown in the other figures. Likewise, any of the features, components, and/or parts, including the arrangements and configurations thereof shown in the other figures may be included, either alone or in any combination, in the example of the devices, features, components, and parts shown in FIG. 7.

Although various representative embodiments of this invention have been described above with a certain degree of particularity, those skilled in the art could make numerous alterations to the disclosed embodiments without departing from the spirit or scope of the inventive subject matter set forth in the specification and claims. The various embodiments discussed herein are not exclusive to their own individual disclosures. Each of the various embodiments may be combined with or excluded from other embodiments. All directional references (e.g., upper, lower, upward, downward, left, right, leftward, rightward, top, bottom, above, below, vertical, horizontal, clockwise, and counterclockwise) are only used for identification purposes to aid the reader's understanding of the embodiments of the present invention, and do not create limitations, particularly as to the position, orientation, or use of the invention unless specifically set forth in the claims. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected with another part. However, those skilled in the art will recognize that the present invention is not limited to components that terminate immediately beyond their points of connection with other parts. Thus, the term “end” should be interpreted broadly, in a manner that includes areas adjacent, rearward, forward of, or otherwise near the terminus of a particular element, link, component, part, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

Other examples and implementations are within the scope and spirit of the disclosure and appended claims. For example, features implementing functions may also be physically located at various positions, including being distributed such that portions of functions are implemented at different physical locations. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. A trailing arm assembly for connection with a row unit of an agricultural planter, the trailing arm assembly comprising:
a closer frame; and
a walking arm assembly pivotally connected to the closing frame, wherein the walking arm assembly includes:
a first closing wheel rotationally mounted toward a first end of the walking arm assembly; and
a second closing wheel trailing the first closing wheel and rotationally mounted toward a second end of the walking arm assembly such that as the first closing wheel lifts, the second closing wheel drops and vice versa;
wherein the first closing wheel comprises:
a circular disc having a first surface and a second surface opposite the first surface, the circular disc including a first outer diameter; and
a depth control band extending laterally from the first surface, the depth control band including a second outer diameter less than the first outer diameter.

2. The trailing arm assembly of claim 1, wherein the band comprises a tubular structure.

3. The trailing arm assembly of claim 2, wherein the tubular structure includes a central longitudinal axis parallel to a rotational axis of the disc.

4. The trailing arm assembly of claim 3, wherein the depth control band includes a thickness extending greater than 0.5 inches along the central longitudinal axis.

5. The trailing arm assembly of claim 2, wherein the depth control band is disposed concentric with the disc.

6. The trailing arm assembly of claim 1, wherein:
the first outer diameter is between 6-inches and 12-inches; and
the second outer diameter is between 4-inches and 10-inches.

7. The trailing arm assembly of claim 1, the first surface faces away from the closing frame and the second surface faces toward the closing frame such that the disc is disposed between the depth control band and the closing frame.

8. The trailing arm assembly of claim 1, wherein the disc is angled such that the first surface faces downward toward a field surface during use.

9. A trailing arm assembly for an agricultural planter, the trailing arm assembly comprising:
a closer frame;
a walking arm pivotally connected to the closing frame, the walking arm having a first end and a second end opposite the first end, the second end trailing the first end;
a first disc rotatably connected to the second end; and
a closing wheel rotatably connected to the first end, the closing wheel comprising:
a closer disc having a body between a first surface and a second surface opposite the first surface, the closer disc including a first outer diameter; and
a tubular depth control band extending from the first surface and concentric with the body, the depth control band including an outer diameter less than the first outer diameter.

10. The trailing arm assembly of claim 9, wherein the depth control band is welded to the body.

11. The trailing arm assembly of claim 9, wherein the depth control band is removably secured to the body.

12. The trailing arm assembly of claim 9, wherein the depth control band is integrally formed as a single piece with the body.

13. The trailing arm assembly of claim 9, wherein the closing wheel further comprises a central hub defining a rotational axis and the depth control band is disposed between the central hub and an outer perimeter edge of the body.

14. The trailing arm assembly of claim 13, wherein:
the depth control band includes a thickness extending longitudinally along the rotational axis; and
the thickness extends at least 0.5 inches away from the first surface.

15. The trailing arm assembly of claim 9, wherein:
the closing wheel is a first closing wheel;
the depth control band is a first depth control band; and
the trailing arm assembly further comprises a second closing wheel having a second depth control band extending therefrom.

16. A closing wheel configured to be rotatably secured to trailing arm assembly of an agricultural planter, the closing wheel comprising:
a circular disc having a first surface and a second surface opposite the first surface, the circular disc including an outer radial edge defining a first outer diameter;
a central hub defining an axis of rotation; and
a tubular depth control band extending laterally from the first surface between the outer radial edge and the hub, the depth control band including a second outer diameter less than the first outer diameter.

17. The closing wheel of claim 16, wherein the second outer diameter is at least 2-inches less than the first outer diameter.

18. The closing wheel of claim 16, wherein the depth control band extends laterally at least 0.5 inches.

19. The closing wheel of claim 16, wherein:
the disc comprises a first metal;
the depth control band comprises a second metal; and
the depth control band is welded to the disc.

20. The closing wheel of claim 16, wherein:
the disc comprises a first material;
the depth control band comprises a second material different from the first material; and
the depth control band is removably secured to the disc.
